(19) United States
(12) Patent Application Publication
(10) Pub. No.: US 2012/0064292 A1
(43) Pub. Date: Mar. 15, 2012

(54) Support Material for Double-Sided Silver Halogenide Photo Paper

(75) Inventors: Christoph Kozlowski, Osnabruck (DE); Hans-Ulrich Berner, Hilter (DE)

(73) Assignee: Felix Schoeller jr. Foto-und Spezialpapiere GmbH & Co. KG, Osnabruck (DE)

(21) Appl. No.: 13/229,045

(22) Filed: Sep. 9, 2011

(30) Foreign Application Priority Data
Sep. 10, 2010 (EP) 10176230.0

(51) Int. Cl. B32B 29/00; B32B 27/10; B32B 3/30; B32B 27/32; B32B 5/16

(52) U.S. Cl. 428/141; 428/537.5; 428/523; 428/327; 428/341; 428/513; 428/454

(57) ABSTRACT

A substrate for coating on both sides with background layers containing photographic silver-halide, comprising at least one base paper with synthetic resin layers formed on both sides and functional layers on the sides of the synthetic resin layers facing away from the base paper, wherein the functional layers contain at least one water-soluble binding agent, a multivalent alcohol, a salt of an inorganic acid and synthetic resin particles for the production of photo books.

### CROSS REFERENCE TO RELATED APPLICATIONS

This application claims priority under 35 U.S.C. §119(e) to and benefit of European Application No. EP 10176230.0, filed Sep. 10, 2010, which is incorporated herein by reference in its entirety.

### TECHNICAL FIELD OF THE INVENTION

The invention relates to a paper substrate for a silver halide background material for top quality photographic reproduction. It relates in particular to a carrier material for the photographic production of photobooks, the individual pages of which may contain photographs on the front and back sides.

### BACKGROUND OF THE INVENTION

Photo books may be individually designed using digital image data. The pages are exposed using digital exposure techniques on pages or webs of light-sensitive photographic paper and bound into a book after photographic development. This saves the user having to stick and label individual images in photo albums.

Photographic paper known in the art is designed to have photos printed on one side; the silver-halide-containing layers that produce the image are only applied to one side of the carrier material and following exposure and processing an image is only reproduced on one side. The carrier materials used for the preferred production of color images are usually paper coated on both sides with synthetic resins. The properties and production of these sorts of carrier materials is described, for example, in “Science and Technology of Photography”, 1St edition, published by KELLER, Karlheinz, Weinheim; VCH Verlagsgesellschaft mbH, 1993, pp 69 to 74.

The production of photo books using traditional, photographic paper with images on one side can be achieved by gluing two pages or webs together back to back; a process and a device for this is described for example in EP 1 955 866 A1. However, gluing represents an additional costly step in book production. The book pages produced in this way are also more than twice the thickness of the photographic paper used, which is often undesirable. The disadvantage of thin photographic paper in particular, which is used to reduce the thickness of the book pages, is that it often leads to handling problems in customary photographic exposure and development equipment, due to its lack of stiffness.

Other digital printing techniques for the production of book pages in photo books are also known in the art, such as inkjet printing or electro-photographic printing processes using toners, for example. The photo pages produced using these sorts of printing techniques have hitherto differed in many respects, such as gloss, feel and long-term image stability, from photo pages produced photographically using light-sensitive material and are therefore less desirable.

The invention addresses the problem of supplying a substrate material for coating on both sides with one or several photo-emulsion layers, which, after coating with photo emulsion, exposure of an image and wet-chemical development of both sides, produces a visual impression on both sides that is comparable with that on a traditional carrier material on which images can only be reproduced on one side.

In addition, good adhesion of the photo-emulsion layers to both sides of the carrier material should be achieved.

The carrier material must not stick together when rolled up or exhibit a strong tendency towards adhesion of its surfaces.

The carrier material according to the invention must not become electrostatically charged during further processing, particularly during unwinding, as the resulting discharge processes may damage and pre-expose the photo-emulsion layers.

Finally, the carrier material should display a high whiteness and a high opacity, in order to produce a picture quality comparable with a carrier material on which images can only be reproduced on one side and prevent the image applied to the back from shining through.

This problem is solved by a substrate for coating on both sides with background layers containing photographic silver-halide, comprising at least one base paper with synthetic resin layers formed on both sides and functional layers on the sides of the synthetic resin layers facing away from the base paper, wherein the functional layers contain at least one water-soluble binder, a multivalent alcohol, a salt of an inorganic acid and particles of a synthetic resin dispersion.

The invention provides a substrate that can be coated on both sides with one or several image-recording layers and enables high-grade pages that can have images reproduced on both sides, for use in photo books, for example, to be produced. The carrier material can be manipulated either in webs or sheets throughout the entire following process of coating with light-sensitive layers, exposure, wet-chemical photographic development and further processing into a photo book, without this resulting in bonding or strong adhesion of the material surfaces to one another; electrostatic charges and discharges are avoided. At the same time, however, good adhesion of the photographic emulsion layers is guaranteed.

After coating on both sides with photo-emulsion layers, exposure of both sides and wet-chemical development of both sides, the substrate according to the invention produces images, the picture quality of which is equal to that of single-sided images on a traditional carrier. It exhibits no bonding or problematic adhesion of surfaces to one another when it is rolled up and unrolled. In addition, it displays no electrostatic charging during further coating with photo-emulsion, which causes damage and blackening of the photo-emulsion layers. Adhesion of a photo-emulsion applied to both sides of the substrate according to the invention is guaranteed.

The synthetic resin layers applied by extrusion, for example, may exhibit a roughness, measured as an Rz value according to DIN 4768, of less than 2 μm for a substrate used for the production of glossy images or of less than 15 μm for a substrate used for the production of matt images.

The functional layers applied to the synthetic resin layers on both sides contain at least one water-soluble polymer, a water-miscible, multivalent alcohol, a salt of an inorganic acid, and synthetic resin particles. These may have a mean particle size of 2 μm to 20 μm. They may have a melting range of over 110° C.

### DETAILED DESCRIPTION OF THE INVENTION

For the purposes of the invention, the term “raw paper” is understood to mean uncoated or surface-glued paper. It may be produced using bleached pulp.

Raw paper may contain, in addition to pulp fibers, gluing agents and alkyl ketene dimers, fatty acids and/or fatty acid salts, epoxidised fatty acid amides, alkenyl or alkyl succinic acid anhydride, wet strengthening agents such as polyamine-polyamide-epichlorohydrin, dry strengthening agents such as anionic, cationic or amphoteric polyamides, starch, optical brighteners, pigments, dyes, anti-foaming agents and other auxiliary agents known in the paper industry. The untreated paper may be surface-glued. Glues suitable for this include, for example, polyvinyl alcohol or oxydised starch. The raw paper may be produced on a Fourdrinier or Yankee paper machine (cylinder paper machine). The grammage of the untreated paper may be 50 to 250 gm², particularly 50 to 150 g/m ². The raw paper may be used in compressed or uncompressed for smoothed). Particularly suitable are raw papers with a density of 0.8 to 1.05 g/m³, particularly 0.95 to 1.02 g/cm³.

Particularly preferable are raw papers containing mineral filling agents. These filling agents, for example kaolin, calcium carbonate in its natural form as chalk, marble or dolomite brick, precipitated calcium carbonate, calcium sulphate, barium sulphate, titanium dioxide, talcum, silica, aluminum oxide and mixtures of these may be used in the untreated paper. These sorts of raw papers may displayer greater opacity compared with untreated papers without filling agents, which can advantageously prevent the photographic image produced on one side from shining through when looking at the image on the other side.

A base paper within the meaning of the invention is an raw paper coated on both sides with a thermoplastic resin, for example a polyolefin or polyolefin mixture. The resin layers may be applied to the raw paper by extrusion.

In a further embodiment of the invention, a further layer may be disposed between the raw paper and the synthetic resin layers on both sides of the raw paper on at least one side, which contains a hydrophilic binder. Particularly suitable for this are film-forming starches, such as thermally modified starches, particularly corn starches or hydroxypropylated starches. Low-viscosity starch solutions with Brookfield viscosities within a range from 50 to 600 mPas (25% solution 50° C./100 Upm), particularly 100 to 400 mPas, preferably 200 to 300 mPas, may preferably be used. The Brookfield viscosity is measured in accordance with ISO 2555. The hinder preferably contains no synthetic latex. The absence of a synthetic binder means that material waste can be reused without prior processing.

In a further embodiment of the invention, the further layer containing a hydrophilic binder also contains at least one pigment. The pigment may he selected from the group of metal oxides, silicates, carbonates, sulphides and sulphates. Particularly well-suited are kaolins, talcum, calcium carbonate and/or barium sulphate.

Particularly preferable is a pigment with a narrow grain size distribution in which at least 70% of the pigment particles are smaller than 1 μm. In order to produce the desired effect, the proportion of pigment with the narrow grain size distribution relative to the entire volume of pigment should be at least 5% by weight, particularly 10 to 90% by wt. Particular good results can be achieved with a proportion of 30 to 80% by wt. of this pigment relative to the total pigment.

According to the invention, a pigment with a narrow rain size distribution also includes pigments with a grain size distribution in which at least roughly 70% by wt. of the pigment particles exhibit a size smaller than roughly 1 μm and for 40 to 80% by wt. of these pigment particles the difference between the pigment with the largest grain size (diameter) and the pigment with the smallest grain size is less than roughly 0.4 μm. A calcium carbonate with a d50% value of roughly 0.7 μm proved particularly advantageous.

In accordance with an embodiment of the invention, a blend of pigments may be used, which contains calcium carbonate and kaolin. The quantity ratio of calcium carbonate to kaolin is preferably 30:70 to 70:30.

The binder/pigment quantity ratio in the additional layer may be 0.1 to 2.5, preferably 0.2 to 1.5, but particularly 0.9 to 1.3.

The layer containing a hydrophilic binder may preferably contain further polymers and polyamide copolymers and/or polyvinylamine copolymers. The polymer may be used in a quantity of 0.4 to 5% by wt., relative to the mass of the pigment. In accordance with a preferred embodiment, the quantity of polymer is 0.5 to 1.5% by wt.

The layer containing the hydrophilic binder may be disposed directly on one or both sides of the untreated paper. It may be in the form of a single layer or multi-layered on the untreated paper. The coating compound may be applied inline or offline using any application units commonly found in paper production, wherein the quantity is chosen such that after drying the application weight per layer is greater than 20 g/m², particularly 8 to 17 g/m² or in accordance with a particularly preferred embodiment, 2 to 6 g/m ².

This further layer may be additionally smoothed using mechanical processes such as calendaring or ferrotyping, but it may also be applied by the cast-coating method.

The layers of synthetic resin may be applied by extrusion to both sides of the raw paper. In accordance with an embodiment of the invention, the synthetic resin layers may contain the same polymer on both sides. In a further embodiment of the invention, the polymers used in the synthetic resin layers of both sides are different.

The synthetic resin layers disposed on both sides of the raw paper preferably contain a polymer with a water vapor permeability of maximum 150 g/²×24 h with a layer thickness of 30 μm, measured at 40° C. and 90% relative atmospheric humidity.

The polymer is preferably a thermoplastic polymer. Suitable thermoplastic polymers include, for example, poly-olefins, particularly low-density polyethylene (LDPE), high-density polyethylene (HDPE), ethylene/α-olefin copolymers (LLDPE), polypropylene, polyisobutylene, polymethylpentene and mixtures of these. However, other thermoplastic polymers, such as (meth)acrylic acid ester homopolymers, (meth)acrylic acid ester copolymers, vinyl polymers and polyvinyl butyral, polyamides, polyester, polyacetals and/or polycarbonates may also be used.

Particularly preferred is low-density polyethylene (LDPE) or a polyethylene mixture of low-density polyethylene (LDPE) and high-density polyethylene (HDPE), wherein the quantity ratio LD/HD may be 9:1 to 1:9, particularly 9:1 to 9:3.

In a preferred embodiment of the invention, the sides of the raw paper are coated with a polymer layer containing at least 50% by wt., particularly at least 80% by wt., of a low-density polyethylene with a density of 0.910 to 0.930 g/cm ³ and a melt flow index of 1 to 20 g/10 min, relative to the polymer layer.

In a preferred embodiment of the invention, the synthetic resin layers may further contain white pigments such as titanium dioxide in on one or both sides.

The proportion of a white pigment means that the opacity of the substrate may be advantageously increased in one or both synthetic resin layers and the sharpness of the photographic image produced may be improved. In addition, one or both synthetic resin layers may contain further auxiliary agents, such as optical brighteners, dyes and auxiliary dispersing agents.

The application weight of the polymer layers on the front and back sides may be 5 to 50 each, preferably 20 to 50 g/m² or particularly preferably 30 to 50 g/m².

In an embodiment of the invention in which the substrate can be used to produce gloss images, surface roughness is achieved using correspondingly structured cooling cylinders with a roughness value smaller than 2 μm, measured as the Rz value according to DIN 4768. Particularly preferable in this case is a roughness of 0.80 μm to 1.90 μm, particularly 1.00 μm to 1.70 μm, with a particularly uniform roughness depth distribution with a standard deviation for Rz of between 0.050 μm and 0.120 μm, preferably around 0.060 μm to 0.100 μm.

In a further preferred embodiment of the invention, in which the substrate is used for the production of matt images, a surface roughness through the use of correspondingly structured cooling cylinders with a value of 2 μm to 15 μm, measured as an Rz value according to DIN 4768, can he produced.

Functional layers are applied to at least one side of the base paper, but preferably to both sides. These function layers are formed in such a way that they have an antistatic effect, exhibit anti-blocking properties and promote adhesion of the silver salt emulsion to the synthetic resin surface. The functional layers contain at least one water-soluble polymer, a water-miscible, multivalent alcohol, a salt of an inorganic acid, and fine synthetic resin particles.

The water-soluble polymer in the functional layer according to the invention may be polyvinyl alcohol, starch or another water-soluble polymer. Particularly preferable is gelatin.

The water-miscible, multivalent alcohol may be a glycol such as ethylene glycol or propylene glycol or another multivalent alcohol, particularly preferable is glycerin.

According to a preferred embodiment, the salt of an inorganic acid may be an alkali metal chloride or alkali metal nitrate, particularly preferably sodium nitrate or lithium nitrate.

The synthetic resin particles may be a synthetic resin with a melting range above 110° C. The synthetic resin particles may have an average particle size of 2 μm to 20 μm, particularly preferably of 4 μm to 10 μm. In a preferred embodiment, the synthetic resin particles contain polyethylene.

The functional layer is made from a coating liquid, which may contain further auxiliary additives such as wetting agents or thickeners, in addition to a synthetic resin dispersion supplying the synthetic resin particles and the aforementioned constituents of the functional layers.

The coating liquid preferably contains water as the solvent as the main constituent.

The application to both sides of the functional layer may take place inline or offline using all application units customary in paper production. The application amount per layer after drying is a of 2.0 g/m², particularly 100 mg/m² to 1 g/m².

It is advantageous to treat the raw paper surface or the base paper surface with corona treatment or sing gas plasma before the synthetic resin layer is applied to the untreated paper or functional layer.

The following examples serve to further illustrate the invention.

### EXAMPLE

Raw paper made from eucalyptus pulp was used to produce the base paper A. For grinding, the pulp was ground as a roughly 5% aqueous suspension (thick matter) with the help of a refiner to a freeness of 36° SR. The average fiber length was 0.64 mm. The pulp fiber concentration in thin matter was 1% by wt. relative to the pulp suspension mass. Additives were added to the thin matter, such as a neutral sizing agent alkyl ketene dimer (AKD) in a quantity of 0.48% by wt., wet strength agent polyaminepolyamide-epichlorohydrin resin (Kymene®) in a quantity of 0.36% by wt. and a natural CaCO₃ in a quantity of 10% by wt. The quantities relate to the pulp mass. The diluted pulp with a pH value set to roughly 7.5 was transferred to the paper machine screen by the flow box, whereupon sheets were formed by dehydrating the web in the screen section of the paper machine. The paper web was further dehydrated in the press section to a water content of 60% by wt. relative to the web weight. Further drying took place in the drying section of the paper machine using heated drying cylinders. This produced an raw paper with a surface weight of 160 g/m² and a moisture content of roughly 7%.

The raw paper is coated on both sides with a coating compound made up of a styrene acrylate binder and a pigment mixture made up of 50% by wt. calcium carbonate and 50% by wt. kaolin with an application weight of 15 g/m² on each of the two sides. The material thereby obtained is referred to in the following as base material A.

The base paper B is an raw paper that was produced in the same way as the untreated paper in base paper A made from eucalyptus pulp. However, it also contains titanium dioxide in the pulp dispersion in a quantity so that the raw paper web contains 10% by wt. TiO₂ relative to the dry mass upon completion. This raw paper was used directly, without the application of a further coating compound, as the base paper B for the following extrusion coating.

Both sides of the base paper A and B were coated with a polyethylene titanium dioxide mixture of 90% by wt. of a low-density polyethylene (LDEP, 0.923 g/cm³), 10% by wt. titanium dioxide (ruffle) with an application weight of roughly 20 g/m² in the laminator at a speed of roughly 250 m/min. The cooling cylinder was selected in such a way that the resulting surfaces on both sides display a roughness Rz of 1.2 μm with a standard deviation of 0.08 μm, measured as an Rz value according to DIN 4768. The materials obtained are referred to as A1 and B1 in the following; they exhibit a high-gloss surface.

In the same way, the base papers A and B were extrusion-coated with the same polyethylene titanium dioxide mixture, wherein, however, the cooling cylinder was selected in such a way that the resulting surfaces on both sides exhibit a roughness Rz of 11.2 μm with a standard deviation of 1.3 μm. The materials obtained are referred to in the following as A2 and B2; they have a matt-structured surface.

The surfaces of the extrusion-coated materials obtained were coated following corona discharge radiation with coating composition a, b, c, and d and dried, wherein the application weight after drying was 0.5 g/m² in all cases on each of the two surface sides of each material. The composition of the coating compounds a to d is obtained from the following table. A mixture of Carboset® GA 1161 and GA 1339 (manufactured by Lubrizol) is used as the acrylate dispersion and Lubaprint® VP 760/D (manufactured by L.P. Bader, Rottweil, Germany) as the PE wax dispersion; all quantity data relates to the solid substance used:

| Coating composition a | Gelatine | 1.6 | g |
|---|---|---|---|
| (customary adhesive | Chrome alum | 1.0 | g |
| layer) | Isopropanol + butanol | 10.0 g + 7.0 g | |
| | Water | 76.0 | g |
| Coating composition b | Acrylate dispersion | 7.7 | g |
| (customary reverse side | Colloidal silicic acid | 4.2 | g |
| layer) | Precipitated silicic acid | 0.3 | g |
| | Polystyrene sulphonic acid | 0.9 | g |
| | Water | 86.9 | g |
| Coating composition c | Gelatine | 5.2 | g |
| (invention) | Isopropanol + butanol | 10.0 g + 6.6 g | |
| | Glycerine | 1.0 | g |
| | Sodium nitrate | 1.5 | g |
| | Chrome alum | 0.1 | g |
| | PE wax dispersion | 2.6 | g |
| | Water | 73.0 | g |
| Coating composition d | Gelatine | 5.2 | g |
| (invention) | Isopropanol + butanol | 10.0 g + 6.6 g | |
| | Glycerine | 1.0 | g |
| | Lithium nitrate | 1.5 | g |
| | Chrome alum | 0.1 | g |
| | PE wax dispersion | 2.6 | g |
| | Water | 73.0 | g |

The carrier materials obtained underwent the tests described in the following table:

| | |
|---|---|
| Surface resistance | Measured using a comb electrode according to |
| | DIN 53483 |
| Sticking test | Two of the substrate in DIN A4 format |
| | are laid on top of one another at 23° C. and 50% |
| | RH and loaded with a 10 kg weight. After 65 |
| | the sheets are manually separated and the |
| | adhesion/bond evaluated. |
| | +: no sticking |
| | ∘: slight sticking |
| | −: strong sticking |
| Emulsion adhesion | The surfaces of the materials are coated with |
| | a silver bromide gelatin photo emulsion and |
| | after drying at 23° C./50% RH the adhesion |
| | is assessed by sticking on a piece of TESA |
| | 4104 adhesive tape and pulling it off. |
| | +: emulsion remains undamaged |
| | ∘: emulsion pulled away slightly |
| | −: emulsion completely pulled away from the |
| | carrier. |

The test results are summarized in the following Table 1.

TABLE 1

| | | Log (surface | Sticking | Emulsion |
|---|---|---|---|---|
| Material | Surface | resistance/ohm/cm) | test | adhesion |
| A1a | Gloss | 13.2 | − | + |
| (comparison) | | | | |
| A1b | Gloss | 10.1 | + | − |
| (comparison) | | | | |
| A1c | Gloss | 9.9 | + | + |
| (invention) | | | | |
| A1d | Gloss | 8.9 | + | + |
| (invention) | | | | |
| A2a | Matt | 13.3 | − | + |
| (comparison) | | | | |
| A2b | Matt | 10.2 | + | − |
| (comparison) | | | | |
| A2c | Matt | 10.0 | + | + |
| (invention) | | | | |
| A2d | Matt | 9.1 | + | + |
| (invention) | | | | |
| B1a | Gloss | 13.2 | − | + |
| (comparison) | | | | |
| B1b | Gloss | 9.9 | + | − |
| (comparison) | | | | |
| B1c | Gloss | 9.8 | + | + |
| (invention) | | | | |
| B1d | Gloss | 9.1 | + | + |
| (invention) | | | | |
| B2a | Matt | 13.1 | − | + |
| (comparison) | | | | |
| B2b | Matt | 10.1 | + | − |
| (comparison) | | | | |
| B2c | Matt | 10.2 | + | + |
| (invention) | | | | |
| B2d | Matt | 9.0 | + | + |
| (invention) | | | | |

1. A substrate for coating on both sides with background layers containing photographic silver-halide, comprising at least one base paper with synthetic resin layers formed on both sides and functional layers on the sides of the synthetic resin layers facing away from the base paper, wherein the functional layers contain at least one water-soluble binding agent, a multivalent alcohol, a salt of an inorganic acid and particles of a synthetic resin dispersion.

2. The substrate according to claim 1, wherein the water-soluble binder is gelatin.

3. The substrate according to claim 1, wherein the synthetic resin particles are polyolefin particles.

4. The substrate according to claim 1, characterised in that the synthetic resin particles are polyolefin particles.

5. The substrate according to claim 3, wherein the polyolefin particles have a melting range of over 110° C.

6. The substrate according to claim 1, wherein the mean particle size of the synthetic resin particles is 2 μm to 20 μm.

7. The substrate according to claim 1, wherein the mean particle size of the synthetic resin particles is 4 μm to 10 μm.

8. The substrate according to claim 1, wherein the functional layers have an application weight of 0.1 g/m² to 1 g/m² on each side.

9. The substrate according to claim 1, wherein the synthetic layers exhibit a surface roughness of 0.80 μm to 3.0 μm, measured as Rz.

10. The substrate according to claim 1, wherein the synthetic layers exhibit a surface roughness of 6.0 μm to 15 μm, measured as Rz.

11. The substrate according to claim 1, wherein the synthetic layers contain low-density polyethylene (LDPE).

12. The substrate according to claim 1, wherein the synthetic layers contain a white pigment.

13. The substrate according to claim 1, wherein an untreated paper with an inorganic pigment as the filling agent is used as the base paper.

14. The substrate according to claim 13, wherein the inorganic pigment is titanium dioxide, calcium carbonate or kaolin.

15. The substrate according to claim 13, wherein the base paper is an untreated paper with a filling agent content of 2% by wt. to 15% by wt., relative to the mass of the untreated paper.
